(19) United States
(12) Patent Application Publication
(10) Pub. No.: US 2015/0120311 A1
(43) Pub. Date: Apr. 30, 2015

(54) SYSTEM AND METHODS FOR EDUCATION THROUGH PATIENT SAFETY EVENT REPORTING

(71) Applicant: Nikki M. Centomani, North Riverside, IL (US)

(72) Inventors: David B. Mayer, Baltimore, MD (US); Timothy McDonald, Chicago, IL (US); Nikki M. Centomani, North Riverside, IL (US)

(73) Assignee: The Board of Trustees of the University of Illinois, Urbana, IL (US)

(21) Appl. No.: 13/885,108

(22) PCT Filed: Nov. 15, 2011
(86) PCT No.: PCT/US2011/060772

§ 371 Date: Jun. 5, 2014

Related U.S. Application Data
(60) Provisional application No. 61/413,657, filed on Nov. 15, 2010.

(51) Int. Cl. G06Q 10/06; G06Q 50/22; G09B 5/00; G06F 17/30; G09B 19/00

(52) U.S. Cl. CPC G06Q 10/06398; G06F 17/30289; G09B 19/00; G09B 5/00; G06Q 50/22
USPC 705/2; 707/805; 434/219

(57) ABSTRACT

An education tool to assist any trainee or patient or family member, including a resident physician, in learning the skills necessary for proper patient safety event reporting including the identification, mitigation, and prevention of risks, hazards, and harms through a data-entry platform for preparing a report regarding a patient safety event. At all stages of the process, the trainee or resident physician or other reporter will receive feedback of event specific and aggregated patient safety information for purposes of trainee or other education. A national database to which events will be reported allows for aggregated sharing of the trainee or other reported occurrences.

This application claims the benefit of U.S. Provisional Application No. 61/413,657 filed Nov. 15, 2010.

### FIELD OF THE INVENTION

The present invention relates generally to data-entry platforms. In particular, the present invention relates to a system and methods for using data-entry platforms to electronically report patient safety events for immediate communication to various parties and educational feedback to the reporter.

The system of the present invention is useful in a variety of industries including, medical, sales, financial, legal, tax, insurance, aviation and research and for a variety of purposes including, at a minimum, education and cause determination.

### BACKGROUND OF THE INVENTION

In many industries, there is a need to be able to communicate and classify occurrences in order to reduce the frequency and severity of such occurrences. For purposes of this application, the term “occurrence” refers to any actual instance where a situation arises. Although the present application is discussed in reference to the medical industry, it is contemplated that the system and methods of the invention described herein may be applicable to any industry.

In the medical industry, a “patient safety event” (“PSE”) is a process or act of omission or commission that results in hazardous healthcare conditions and/or unintended harm to a patient. Therefore, a patient safety event may include an incident, a near miss, or an unsafe condition. Although medical professionals strive to avoid PSEs, when they do occur, not all health care professionals will disclose or report the PSE within their organization or to patients. Transparency related to PSEs is central to the current patient safety movement. Improving patient outcomes, while reducing hazardous conditions and unintended patient harm, depend upon learning from unanticipated or undesirable outcomes and associated errors.

Transparency around medical errors and other relevant information following an unexpected patient safety event provides opportunities for increased learning that translates into safer systems and methods and improvements in patient care.

PSEs arising in medical situations are of particular importance to resident physicians since they often provide the frontline medical care to patients in teaching environments. Since they are still trainees in residency programs, resident physicians practice medicine under the supervision of fully licensed physicians, usually in a hospital or clinic. Successful completion of residency training is usually a requirement to obtaining a license to practice medicine. Although training is valuable, few training programs exist that effectively educate resident physicians about patient safety and risk management and quality medical care, including patient safety event reporting.

The Accreditation Council for Graduate Medical Education (“ACGME”) is responsible for the accreditation of post-MD/DO medical training programs within the United States. Accreditation is accomplished through a peer review process and is based upon established standards and guidelines. The ACGME implements standards and guidelines to progress the quality of health care by improving the quality of graduate medical education experience for resident physicians. The ACGME establishes national standards for graduate medical education by which it approves and continually assesses educational programs in order to ensure quality graduate medical education programs.

The national standards for graduate medical education established by the ACGME require that resident physicians obtain competencies in six areas at levels expected of a new practitioner. The six core competencies include: patient care, medical knowledge, practice-based learning and improvement, interpersonal and communication skills, professionalism, and systems-based practice.

Currently, patient safety events are submitted to a hospital or medical center risk management office without standardized feedback or assessment mechanisms for the reporter. In addition, very few resident physicians report patient safety events. Therefore, no medical center or hospital has created or seen the need to create a reporting process or associated database specifically for resident PSE reports and, certainly, no national depository collects, retains and analyzes resident physician or other health professional learner PSEs. This is considered a major gap in health professional learner education.

As a result and in order to fill this gap from an educational perspective, there is a need for all residency programs, and other health professional training programs, to have a process and system for a safe and secure method of reporting PSEs into a national database for purposes that include training and assessment in the ACGME core competencies or any other credentials of an accreditation authority, cause determination, and care system improvement. The present interview satisfies the need.

### SUMMARY OF THE INVENTION

The present invention can be used in a number of industries for educational and training purposes. Because of the direct applications, the medical industry is used for most of the examples describing the present invention herein, although any industry is contemplated. The present invention can also be used for a wide variety of purposes. Because of the direct applications, patient safety event reporting is used for most of the examples describing the present invention herein, although any purpose is contemplated such as any type of medical or health science education, public health purposes, epidemiological purposes, identifying disease risk factors, patient advocacy purposes, hospital safety, hospital administration, risk management, and insurance to name a few.

The system and methods of the present invention are discussed herein with respect to resident physicians since patient safety events arising in medical situations are of particular importance to residency training, although any person desiring to gain knowledge, information, comprehension or skill in the health care profession or another profession or industry is contemplated Embodiments of the present invention serve as an education tool to assist a trainee, such as a resident physician, in learning the skills necessary for proper patient safety and risk management event reporting including the identification, mitigation, and prevention of risks, hazards, and harms. The present invention also contemplates patients and families to be able to report what they perceive to be patient safety events as defined herein.

The present invention pertains to a system and methods to immediately report patient safety events. According to the present invention, the terms “patient safety event” or “PSE” refers to “a process or act of omission or commission that results in hazardous healthcare conditions and/or unintended harm to a patient.” A Patient safety event may include an incident, a near miss, or an unsafe condition. For purposes of this application, the term “incident” refers to a patient safety event that reached the patient, whether or not the patient was harmed and the term “near miss” refers to a patient safety event that did not reach the patient. A “near miss” as used herein refers to an unplanned event that did not result in injury, illness, or damage but would have a high likelihood of resulting in an injury if repeated again. The term “unsafe condition” means for purposes of this application “any circumstance that increases the probability of a patient safety event”. Such circumstances include any culturally imbedded element such as but not limited to excessive work hours, fatigue, stress, lack of supervision, ineffective hand-offs, disruptive and unprofessional behaviors.”

The present invention is directed to a system and methods by which a resident physician, other trainees, or patients and families can report PSEs occurring in any clinical location and thereby provide the first step in reducing the frequency and severity of such occurrences, and overall to improve the quality of patient care. The present invention identifies opportunities to improve patient safety by capturing and analyzing patient safety events, thereby facilitating the identification of root causes of the events and opportunities to implement changes—system or operational—to prevent reoccurrence.

According to the present invention, resident physicians self-report PSEs electronically to a platform. The platform is linked to a database that allows for individual feedback to the reporter and for aggregated sharing of the reported PSEs. Therefore, residency programs across the United States may have access to the database reports for various purposes, such as for benchmarking, education, and accreditation. It is also contemplated that the database will provide electronic linkages to appropriate medical centers, hospitals and clinics. It is further contemplated that appropriately de-identified and aggregated reports created from the database may be provided to various organizations including patient, accreditation, educational, governmental, and societal groups such as the Patent Safety Organization (“PSO”), Accreditation Council for Graduate Medical Education (“ACGME”), Association of American Medical Colleges (“AAMC”), Health and Human Services (“HHS”), Agency for Health care Research and Quality (“AHRQ”), and the Consumers Union.

Reports residing in the database can be prepared without or subsequently scrubbed of all provider and patient identifiable health information. Therefore, reports can be created wherein even parties accessing the database and particularly the reports are not aware of the identifying features associated with the report such as the patient, resident physician, and/or medical center associated with the report.

In addition to education and training, the PSE reporting data may be used for cause determination, pattern of error recognition, care system improvement, and addressing of potential patient compensation for a preventable adverse event with consequences to the patient.

The present invention can provide immediate notification of a submitted report to necessary parties, for example, the residency program director, hospital officials, patient safety and risk management officers or departments. For purposes of this application, the term “immediate” means a measured time period such as by second, minutes, hours, weeks or even months.

Immediate notification is also provided to the resident physician, or other reporter, in the form of educational feedback based on a category and a description of events that includes at least one selected from the group of references of peer reviewed literature and best practices related to the patient safety event reported. For example, educational feedback includes, but is not limited to, the provision of references and abstracts from the medical literature that will give best practice recommendations or guidelines on preventing or rectifying the PSE, including unsafe conditions. Additionally, educational assessment questions related to the educational feedback will be submitted to the resident physician. Residents would complete the assessment questions demonstrating a level of knowledge and competency in different PSE domains, with answers electronically placed in the database along with the resident's PSE report. In another embodiment of the present invention, the automated educational feedback and assessment tool will also track and evaluate resident physician learning over the continuum of their academic career through a resident physician educational portfolio that tracks and evaluates the educational and training progress related to the PSE reports and subsequent follow-up. It is contemplated that the educational feedback may also be provided to other parties such as to the residency program director or patients and families when indicated.

One embodiment of the reporting system and methods provides a data-entry platform that includes a plurality of user input interfaces, or screens, through the use of which various data regarding the occurrence may be entered. In one embodiment, the data-entry platform includes a “home page” screen that requires data such as a valid user name and a valid password in order to grant access to the system. Upon entering a valid user name and valid password, a first screen is displayed. The first screen is unique to the user and includes information that is specific to the physician resident such as name, ACGME number, and program. The first screen may further include an entry for the type of patient safety event.

An embodiment of the present invention may include a second screen of the platform that is displayed depends on the type of PSE reported. With an incident, a near miss, or an unsafe condition, the second screen requires the selection of an incident category from a plurality of categories. The plurality of incident categories displayed is specific to the type of PSE. The second screen also may require input of event location, brief description of the event, and hospital location. If the event is an “incident” or “near miss”, then further information is required, such as name and medical record number of the patient.

The next screen prompts the resident physician to identify any of the Institute of Medicine (“IOM”) “aims for improvement” they consider related to the event. The first of such aims is that health care must be safe, that is, that injuries should be avoided. The second aim is that health care must be effective, that is, it should match science, with neither underuse nor overuse of the best available techniques. As examples, every elderly heart patient who is thought to be able to benefit from beta-blockers should get them, and no child with a simple ear infection should get advanced antibiotics. The third aim is that health care should be patient-centered, that is, each patient's culture, social context, and specific needs should be respected, and the patient should be allowed to play an active role in making decisions about his or her own care. The fourth aim is that health care should be timely. Unintended waiting that doesn't provide information or time to heal is a system defect. Prompt attention benefits both the patient and the medical professional. The fifth aim is that health care should be efficient, constantly seeking to reduce the waste—and thereby cost—such as of supplies, equipment, space, capital, ideas, time, and opportunities. The last aim is that health care should be equitable. Race, ethnicity, gender, and income should not prevent anyone from receiving high-quality care.

Upon inputting their assessment of applicable IOM aims, the fourth screen requires the resident to assess elements of the event that may be related to the ACGME core competencies discussed more fully below.

The last screen is a submission screen confirming the submission of the report.

One important aspect of the present invention is that the various embodiments of the invention provide for education and training in the ACGME core competencies of patient care, medical knowledge, practice-based learning and improvement, interpersonal and communication skills, professionalism, and systems-based practice.

Resident physicians must be able to provide patient care that is compassionate, appropriate, and effective for the treatment of health problems and the promotion of health. Under the first ACGME core competency, resident physicians are expected to perform the following: communicate effectively; demonstrate caring and respectful behaviors when interacting with patients and their families; gather essential and accurate information about their patients; make informed decisions about diagnostic and therapeutic interventions based on patient information/preferences, up-to-date scientific evidence, and clinical judgment; develop and carry out patient management plans; counsel and educate patients and their families; use information technology to support patient care decisions and patient education; perform competently all medical and invasive procedures considered essential for the area of practice; provide health care services aimed at preventing health problems or maintaining health; and work with health care professionals, including those from other disciplines, to provide patient-focused care.

Under the second ACGME core competency, medical knowledge requires that resident physicians demonstrate knowledge about established and evolving biomedical, clinical, and cognate (e.g., epidemiological and social-behavioral) sciences and the application of this knowledge to patient care. Residents are expected to demonstrate also an investigatory and analytic thinking approach to clinical situations as well as know and apply the basic and clinically supportive sciences which are appropriate to their discipline.

With practice-based learning and improvement, resident physicians must be able to investigate and evaluate their patient care practices, appraise and assimilate scientific evidence, and improve their patient care practices. Under the third ACGME core competency, resident physicians are expected to perform the following: analyze practice experience and perform practice-based improvement activities using a systematic methodology; locate, appraise, and assimilate evidence from scientific studies related to their patients' health problems; obtain and use information about their own population of patients and the larger population from which their patients are drawn; apply knowledge of study designs and statistical methods to the appraisal of clinical studies and other information on diagnostic and therapeutic effectiveness; use information technology to manage information, access on-line medical information and support their own education; and, facilitate the learning of students and other health care professionals

Under the fourth ACGME core competency, interpersonal and communication skills require that resident physicians demonstrate skills that result in effective information exchange and collaboration with patients, their families, and professional associates. Residents are expected to create and sustain a therapeutic and ethically sound relationship with patients, use effective listening skills and elicit and provide information using effective nonverbal, explanatory, questioning, and writing skills as well as work effectively with others as a member or leader of a health care team or other professional group.

With respect to the fifth ACGME core competency of professionalism, resident physicians must demonstrate a commitment to carrying out professional responsibilities, adherence to ethical principles, and sensitivity to diverse patient populations. For example, resident physicians are expected to demonstrate respect, compassion, and integrity; a responsiveness to the needs of patients and society that supersedes self-interest; accountability to patients, society, and the profession; and a commitment to excellence and on-going professional development. Furthermore, resident physicians must demonstrate a commitment to ethical principles pertaining to provision or withholding of clinical care, confidentiality of patient information, informed consent, and business practice. Resident physicians must also demonstrate sensitivity and responsiveness to patients' culture, age, gender, and disabilities.

The last core competency—systems-based practice—requires that residents demonstrate an awareness of and responsiveness to the larger context and system of health care and the ability to effectively call on system resources to provide care that is of optimal value. Residents are expected to understand how their delivery of patient care and other professional practices affect other health care professionals, the health care organization, and the larger society and how these elements of the system affect their own practice. Another expectation of resident physicians is the knowledge of how types of medical practice and delivery systems differ from one another, including methods of controlling health care costs and allocating resources. Additional tasks that resident physicians are expected to perform include the following: practice cost-effective health care and resource allocation that does not compromise quality of care; advocate for quality patient care and assist patients in dealing with system complexities; and to know how to partner with health care managers and health care providers to assess, coordinate, and improve health care and know how these activities can affect system performance.

The data-entry platform further includes additional user input interfaces, or screens. These screens of the data-entry platform include, for example, a change password screen, a profile screen, and a “contact us” screen. Additional screens may include information to manage the following: users, IOM aims list, ACGME core competencies, residency program, incident categories, and facility or hospital, to name a few.

### BRIEF DESCRIPTION OF THE DRAWINGS

FIG. 1 illustrates a flow chart of preparing a report directed to an occurrence according to one embodiment of the present invention;

FIG. 2 illustrates a flow chart of creating a report directed to an occurrence as shown in FIG. 1 according to the present invention;

FIG. 3 illustrates a flow chart of offering feedback related to a report as shown in FIG. 1 according to the present invention;

FIG. 4 illustrates a diagram of one embodiment of a plurality of user input interfaces of a data-entry platform according to the present invention;

FIG. 5 illustrates a flow chart of one embodiment of a plurality of user input interfaces of a data-entry platform according to the present invention;

FIG. 6 illustrates a flow chart continued from FIG. 5 and a block diagram of one embodiment of a plurality of user input interfaces of a data-entry platform according to the present invention;

FIG. 7 further illustrates a block diagram of one embodiment of a plurality of user input interfaces of a data-entry platform according to the present invention.

FIG. 8 illustrates a list of categories and items of one embodiment of a data-entry platform according to the present invention;

FIG. 9 illustrates a block diagram of one embodiment of a system for reporting an occurrence according to the present invention;

FIG. 10 illustrates a screen shot of a user input log in interface of the data-entry platform according to the present invention;

FIG. 11 illustrates another screen shot of a user input interface of the data-entry platform according to the present invention;

FIG. 12 illustrates another screen shot of a user input interface of the data-entry platform according to the present invention;

FIG. 13 illustrates another screen shot of a user input interface of the data-entry platform according to the present invention;

FIG. 14 illustrates another screen shot of a user input interface of the data-entry platform according to the present invention;

FIG. 15 illustrates another screen shot of a user input interface of the data-entry platform according to the present invention;

FIG. 16 illustrates another screen shot of a user input interface of the data-entry platform according to the present invention;

FIG. 17 illustrates another screen shot of a learner accessible database generated portfolio of learner PSEs according to the present invention;

FIG. 18 illustrates a computer system that may be used according to the present invention; and

FIG. 19 illustrates a cloud computing system that may be used according to the present invention.

### DETAILED DESCRIPTION OF EMBODIMENTS OF THE INVENTION

The system and methods of the present invention are discussed herein with respect to a resident physician trainee, although any person desiring to gain knowledge, information, comprehension, or skill in the health care profession is contemplated.

The present invention assists resident physician trainees in learning the skills necessary for proper patient safety and risk management event reporting including the identification, mitigation, and prevention of risks, hazards, and harms. Education and training of resident physicians is necessary for proper patient safety and risk management event reporting including the identification, mitigation, and prevention of risks, hazards, and harms. Records of patient safety events are created through a data-entry platform such that a report may be created and entered into a database for aggregated sharing of the reported events.

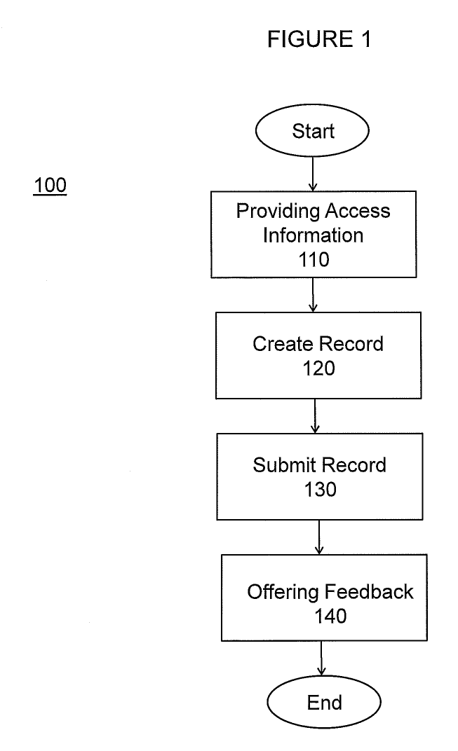

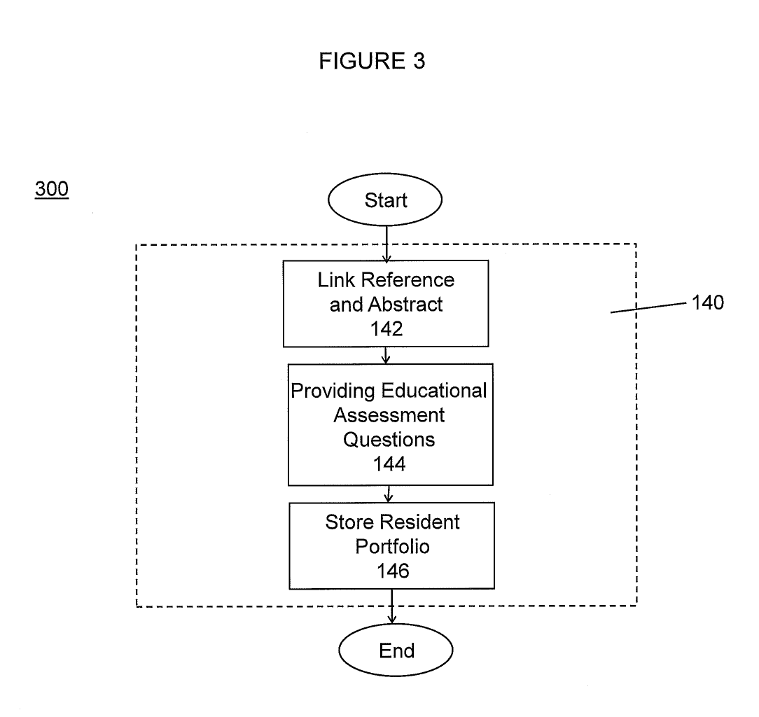

FIG. 1 illustrates a flow chart 100 of preparing a report directed to a PSE, also referred to herein as “event” or “occurrence”, according to one embodiment of the present invention. The PSE is one that could or did result in physical, psychological, or emotional harm to a patient. A PSE may include an incident, near miss, or unsafe condition. As shown in FIG. 1, reports are prepared by providing access information at step 110 described more fully below with respect to the data-entry platform. Upon providing valid access information at step 110, a record or report of the occurrence is created at step 120 and submitted to a national database at step 130. The database allows for aggregate sharing of the reported PSEs. In certain embodiments, immediate notification such as feedback may be offered at step 140 to one or more parties such as a residency program director, hospital safety officer, the Patient Safety Evaluation System (“PSES”) of the clinical enterprise or the resident physician. For example, it is contemplated that the immediate notification may be provided to the resident physician in the form of educational feedback or educational assessment questions as described more fully in reference to FIG. 3.

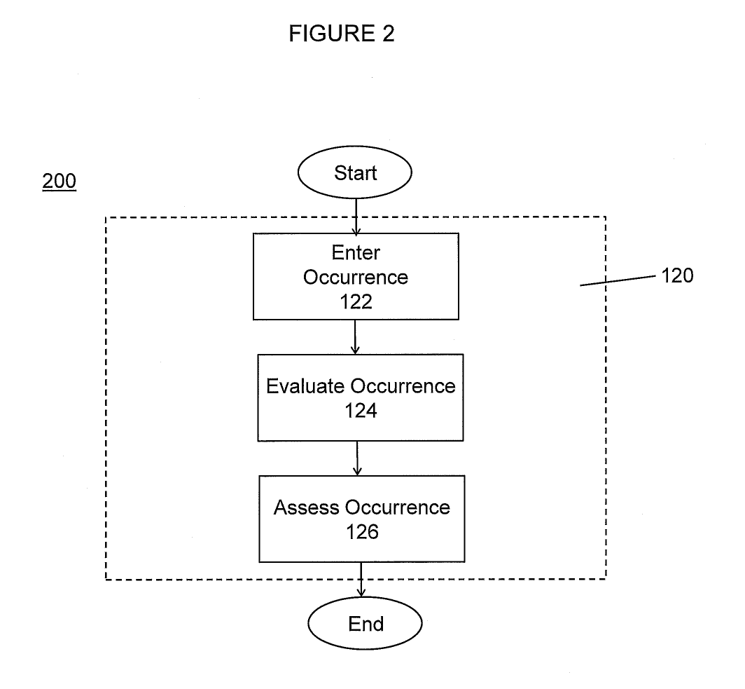

FIG. 2 illustrates a flow chart 200 of creating a record or report directed to a PSE at step 150 as shown in FIG. 1 according to the present invention. Specifically, the report is created at step 120 by entering an event at step 122 selected from the group of a patient safety events described more fully below in reference to FIG. 3 through FIG. 6. At step 124 the event is evaluated based on one or more aims for improvement such as safe, effective, patient-centered, timely, efficient, and equitable care. At step 126 the event is assessed with respect to one or more core competencies such as the ACGME competencies of patient care, medical knowledge, practice-based learning and improvement, interpersonal and communication skills, professionalism, and systems-based practice. The record or report is created (step 120) and submitted. The completed report is submitted and stored within a database such as for further investigation in a Patient Safety Evaluation System (“PSES”) or other aggregate sharing of the reported PSEs. As mentioned above, the report may be communicated immediately to one or more parties.

FIG. 3 illustrates a flow chart 300 of offering feedback at step 140 as shown in FIG. 1 according to the present invention. At step 142, immediate notification in the form of educational feedback is linked to the PSE record or report. Educational feedback linked to the PSE report may include references and abstracts to full articles on best practices or established patient care guidelines from medical literature with suggestions on preventing or rectifying the adverse event. Educational feedback may also include assessment questions related to the report, which are provided to the resident physician trainee at step 144. Educational feedback may also be sent to the resident physician trainee to allow tracking of knowledge acquisition by the resident physician trainee. In addition, educational feedback including the references and abstracts, assessment questions and PSE report can be stored within a portfolio at step 146. The portfolio permits resident physician trainees to access and review prior PSE reports and any follow-up related to the event. The portfolio also permits resident physician trainees to track educational development and progress towards the required knowledge, skills and behaviors necessary for successful completion of their residency.

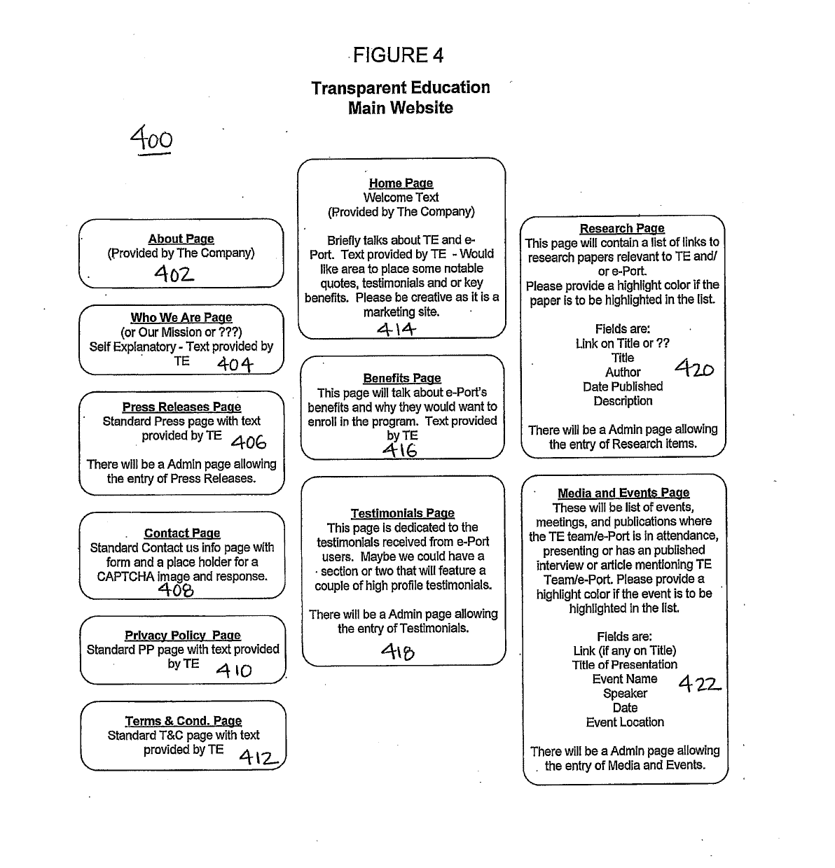

FIG. 4 through FIG. 8 illustrate various embodiments of a data-entry platform according to the present invention. As shown, the data-entry platform includes a plurality of user input interfaces, or screens, to enter various data including the details of the PSE, also referred to herein as event or occurrence.

FIG. 4 illustrates the components of the main website interface 400. The main website interface includes an “About Page” 402 that provides various information about the data-entry platform. A “Who We Are Page” 404 provides information about the company related to the data-entry platform. As shown by 406, a “Press Releases Page” provides for statements or communications that announce something claimed as having news value. A “Contact Page” 408 provides information such as mailing address, phone number and email address. A “Privacy Policy Page” 410 discloses some or all of the ways information pertaining to the user of the data-entry platform is gathered, used, disclosed and managed. A specification of restrictions for the use of the services provided by the data-entry platform is specified on the “Terms & Conditions Page” 412. A “Home Page” 414 is the data-entry platform main page and may contain a table of contents as well as links pointing to other pages. The “Benefits Page” 416 lists the advantages and uses of the data-entry platform. The main website interface 400 also includes a “Testimonials Page” 418 promotes the data-entry platform through current or past users of the invention. A “Research Page” 420 provides links to various research materials and a “Media and Events Page” 422 provide a listing of events, meetings, and presentations relating to the data-entry platform.

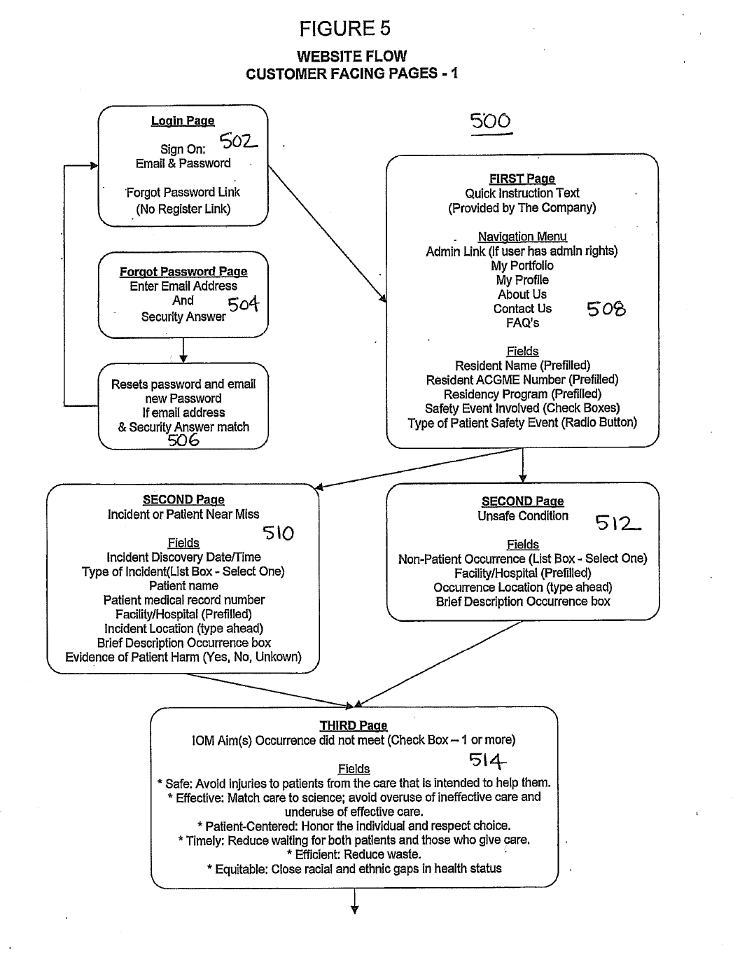

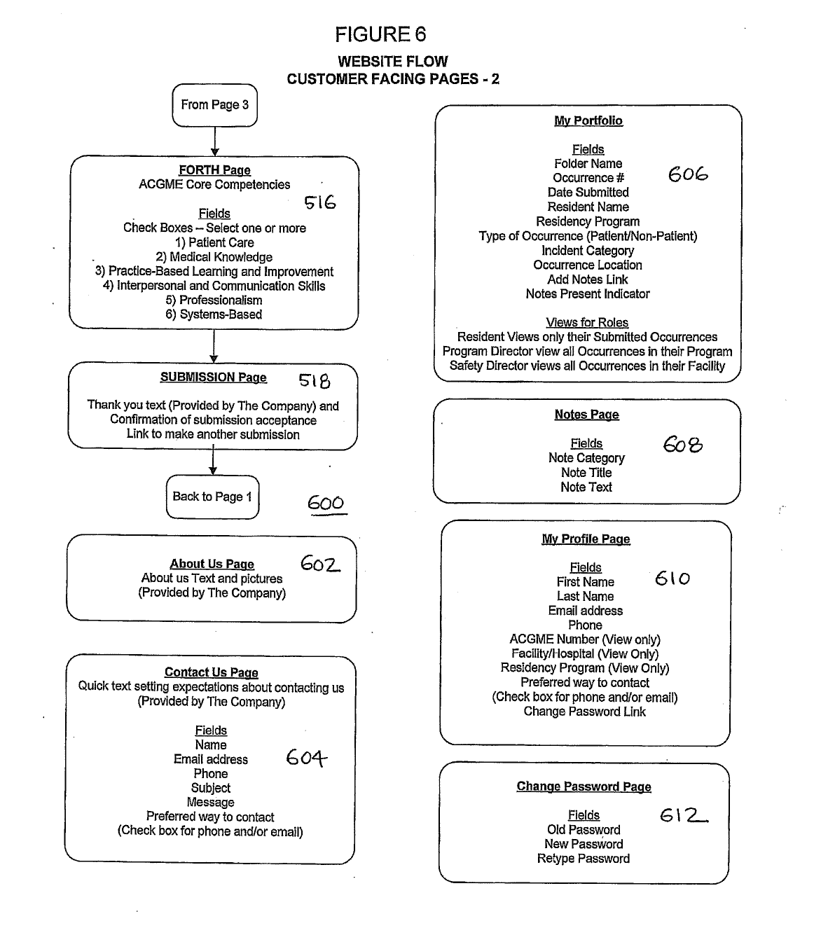

FIG. 5 and FIG. 6 illustrates a flow chart of preparing a report 500 directed to an event according to one embodiment of the present invention. The event is an incident that is one that could or did result in physical, psychological, or emotional harm to a patient. A patient safety event may include an incident, near miss, or unsafe condition. As shown in FIG. 5, reports related to a resident physician identified patient safety event are prepared by providing access information at the “Login Page” 502 such as at least one user name and password. A valid user name and a valid password grant access to the platform. A “Forgot Password Page” 504 enables a trainee to enter an email address and security answer in the event that a trainee fails to obtain access to the platform. Upon providing an email address and security answer, the password is reset and emailed to the trainee as shown by 506.

Upon entering a valid user name and valid password on the “Login Page” 502, a

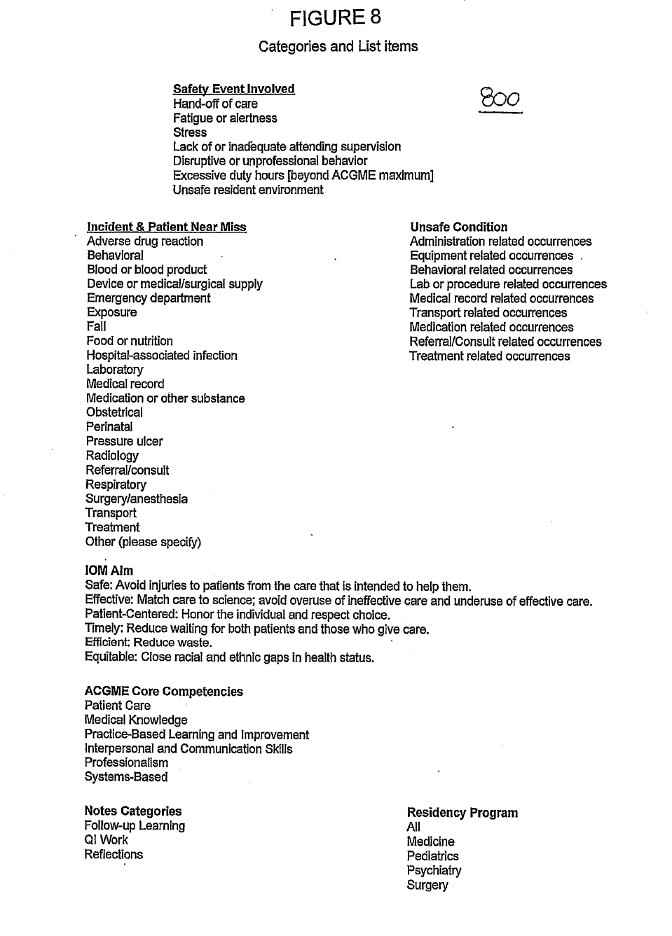

“User Specific Page” 508 is displayed that includes information that is specific to the physician resident such as name, unique ACGME number, residency program and program. The “User Specific Page” 508 further includes an entry for the safety event involved and the type of PSE to report: an “incident”, a “near miss” or an “unsafe condition” (see also FIG. 8).

Upon selection of an “incident” or a “near miss”, “PSE Page” 510 is displayed. “PSE Page” 510 requires the selection of a specific incident or near miss category from a plurality of categories. “PSE Page” 510 also requires input of date and time the incident or near miss was discovered, patient name and record number, event location, brief description of the occurrence, hospital location and evidence of patient harm.

Upon selection of an “unsafe condition”, “PSE Page” 512 is displayed. “PSE Page” 512 requires the selection of a specific unsafe condition category from a plurality of categories. “PSE Page” 512 also requires input of event location, brief description of the occurrence, and hospital location.

After completion of the “PSE Page” 510, 512, an “Institute of Medicine (“IOM”) Page” 514 is displayed. The “IOM Page” 514 displays aims for improvement as specified by the IOM, which as mentioned above include safe, effective, patient-centered, timely, efficient, and equitable care (see also FIG. 8). The trainee may select one or more of the aims for improvement of which the PSE did not meet.

Turning to FIG. 6, the “ACGME Core Competencies Page” 516 is presented that requires the input of information of the occurrence related to the ACGME core competencies (see also FIG. 8). The ACGME core competencies are patient care, medical knowledge, practice-based learning and improvement, interpersonal and communication skills, professionalism, and systems-based practice.

Upon the trainee selecting one or more of the ACGME core competencies related to the PSE, a “Submission Page” 518 is presented. The “Submission Page” 518 includes confirmation of acceptance of the submission of information related to the PSE as well as al link to report any other PSEs. Once submitted, the record of the PSE is submitted to a national database and stored thereon. The database allows for aggregate sharing of the reported PSEs. As mentioned above, the platform may further generate immediate notification in the form of educational feedback or assessment questions related to the PSE report.

FIG. 6 further illustrates a block diagram of one embodiment of a plurality of user input interfaces of a data-entry platform according to the present invention. An “About Us Page” 602 is similar to the “About Page” 402 of the main website interface and provides various information about the entity or organization affiliated with the data-entry platform. The “Contact Us Page” 604 is similar to the “Contact Page” 408 of the main website interface and provides entry fields for a trainee to enter name, email address, phone, subject, message and a preferred method of contact. A “My Portfolio Page” 606 permits a resident physician trainees to access and review prior PSE reports and any follow-up related to the event. The portfolio also permits resident physician trainees to track educational development and progress towards the required knowledge, skills and behaviors necessary for successful completion of their residency. The “My Portfolio Page” 606 also allows the resident physician trainee to track knowledge acquisition by the resident physician trainee. In addition, educational feedback including the references and abstracts, assessment questions and PSE report can be accessed from the portfolio. A “Notes Page” 608 allows the resident physician trainee to enter brief information to aid the resident physician trainee. The “Notes Page” 608 includes a note category, for example, follow-up leaning, Quality Improvement (“QI”) work, and reflections. A “My Profile Page” 610 includes information specific to the resident physician trainee such as name, contact information, residency program, hospital or facility, and ACGME number. The “My Profile Page” 610 further includes a link to a “Change Password Page” 612. The “Change Password Page” 612 allows a trainee to change their password.

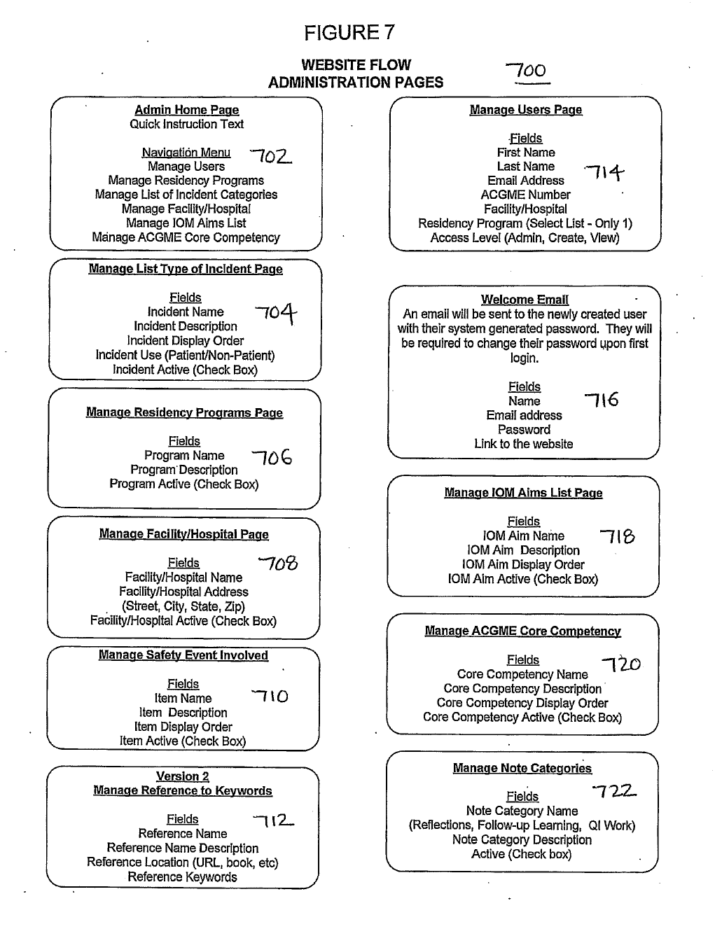

FIG. 7 further illustrates a block diagram of one embodiment of a plurality of user input interfaces of a data-entry platform according to the present invention. More specifically, FIG. 7 illustrates administration pages for the data-entry platform. As shown by the “Admin Home Page” 702, various components of the data-entry platform may be managed such as the users, residency program, incident categories, to name a few. Upon selection of the component to be managed on the “Admin Home Page” 702, the linked page corresponding thereto becomes available. The “Manage List Type of Incident Page” 704 includes the name, description, order, use and status (i.e., active, non-active) of the types of “incident”, “near miss” and “unsafe condition”. The “Manage Residency Programs Page” 706 includes the name, description and status of the residency program. The “Manage Facility/Hospital Page” 708 permits the facility/hospital information to be managed, for example, name, address and status. The safety event involved for selection by the resident physician trainee as shown in the “User Specific Page” 508 of FIG. 5 is managed through the “Manage Safety Event Involved Page” 710 including name, description, display order and status. Reference to keywords including name, description, and location such as URL or book are managed through the “Manage Reference to Keywords Page” 712. Users of the data-entry platform are managed through the “Manage Users Page” 714. The “Manage Users Page 714 includes name, contact information, residency program, hospital or facility, and ACGME number of the resident physician trainee. Upon a newly created trainee within the data-entry platform, a welcome email is sent to the trainee. The welcome email content such as the name, email address, password and link to the data-entry platform are managed through the “Welcome Email Page” 716. The aims for improvement are managed through the “Manage IOM Aims List Page” 718. Specifically, the IOM aim name, description, display order and status are managed through the “Manage IOM Aims List Page” 718. The name, description, display order and status of the ACGME core competencies are managed through the “Manage ACGME Core Competency Page” 720. The “Manage Note Categories Page” 722 allows the management of the category name (i.e., follow-up leaning, QI work, and reflections) as well as the description and status of the note categories.

FIG. 8 illustrates a list of categories and items 800 of one embodiment of a data-entry platform according to the present invention. As shown, the categories and items include a list of the safety event involved for selection by the resident physician trainee as shown in the “User Specific Page” 508 of FIG. 5. The categories and items include a list of the types of “incident”, “near miss” and “unsafe condition” of the “PSE Page” 510, 512 as describe in reference to FIG. 5. The categories and items also includes aims for improvement as specified by the IOM for entry on the “IOM Page” 514 of FIG. 5 as well as ACGME core competencies on the “ACGME Core Competencies Page” 516 as shown in FIG. 6. A notes category includes follow-up leaning, QI work, and reflections for the “Notes Page” 608 of FIG. 6. As shown, the categories and items include various residency programs selectable within the “My Profile Page” 608.

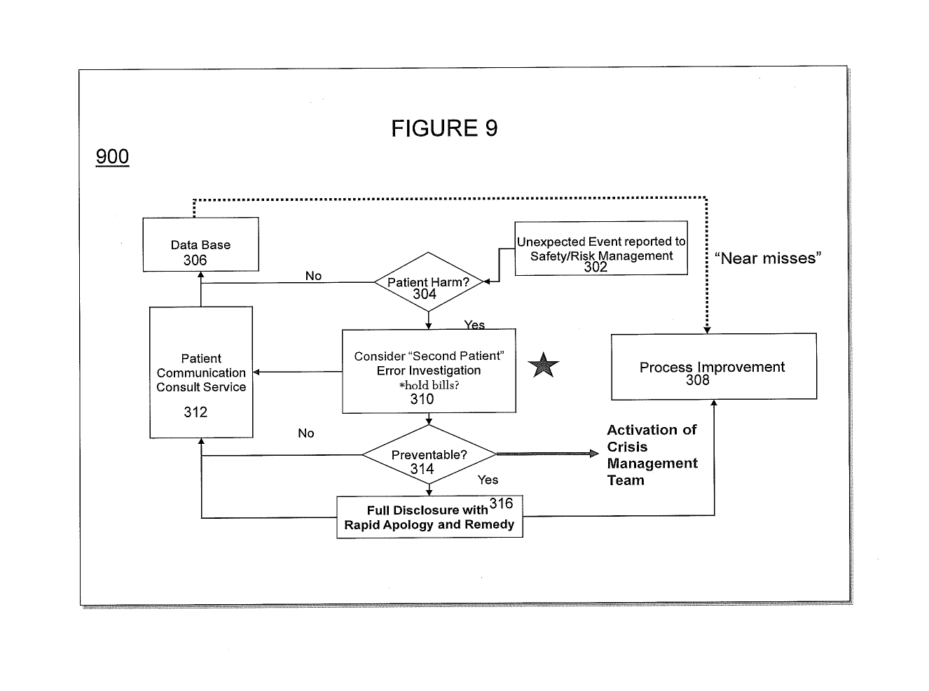

FIG. 9 illustrates a block diagram 900 of one embodiment of a system for reporting a patient safety event according to the present invention. At step 302, the event is reported with respect to a first patient. If there was no physical, psychological, or emotional harm to the first patient, the adverse event is submitted to a database at step 306 such that a process improvement may be determined at step 308. On the other hand, if there was physical, psychological, or emotional harm to the first patient, the adverse event is investigated at step 310 to determine if it occurred with respect to any other patients. The investigation includes consulting a patient communication service at step 312 and determining if the adverse event was preventable at step 314. The results of consulting with the patient communication service at step 312 is documented and submitted along with the adverse event to a database at step 306 such that a process improvement may be determined at step 308. If it is determined that the adverse event was preventable at step 314, full disclosure reporting is conducted at step 316. The full disclosure reporting may be communicated to a patient communication service as shown by step 312 and/or forwarded for process improvement at step 308. Full disclosure reporting includes the step of notifying patient safety/risk management personnel about unexpected adverse events involving patient harm, utilizing standard Root Cause Analysis (“RCA”) techniques of the adverse event to determine whether one or more errors was made in the process, creating communication programs for providing ongoing communication with patients and families following an unexpected adverse event, providing an apology and an appropriate remedy, and linking process improvements identified in the RCA with patient and family involvement.

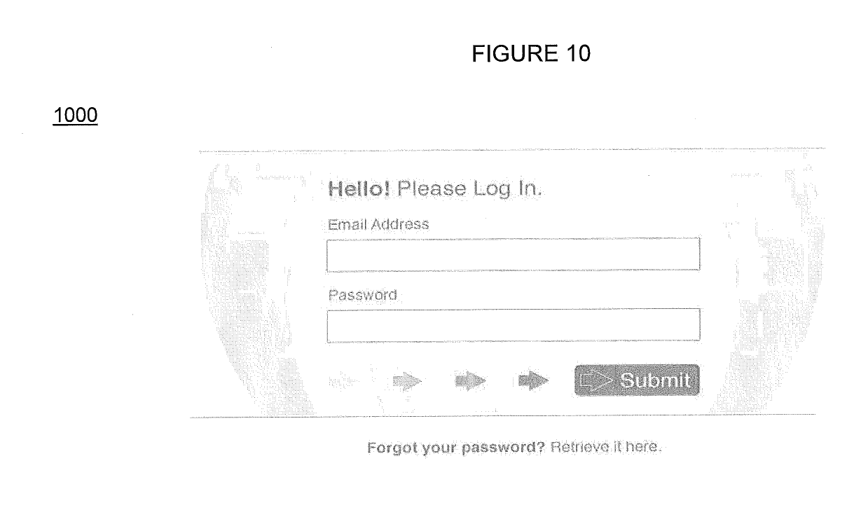

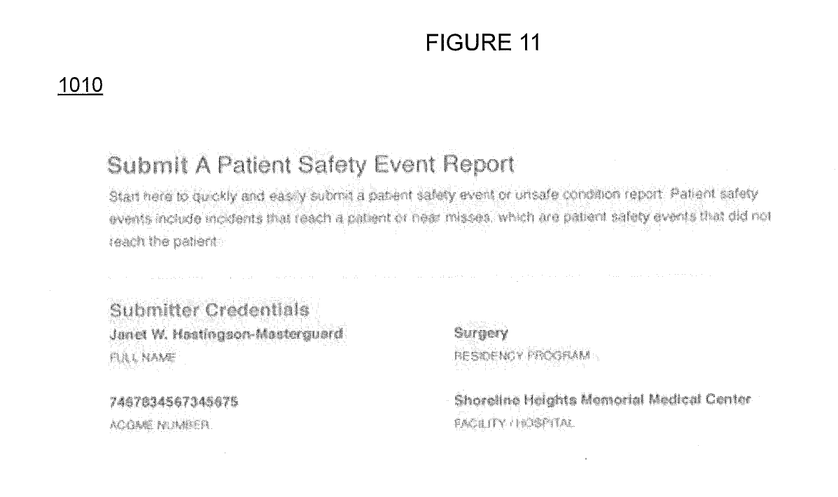

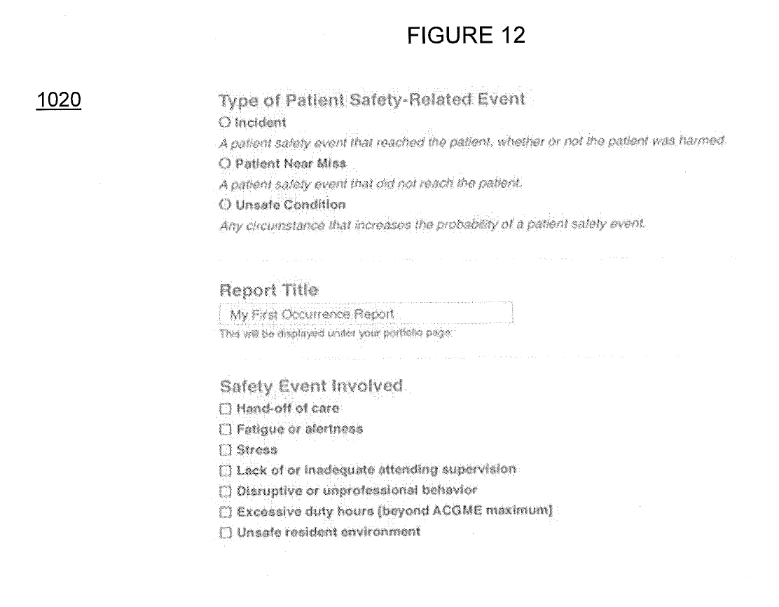

FIG. 10 illustrates a screen-dump of a user input interface of the data-entry platform according to the present invention. The remote data entry screen 1000 as shown in FIG. 10, is directed to the input of unique user log in information. Upon log in, the trainee is directed to a credentials screen 1010 for further verification of user identification as shown in FIG. 11. Following log in identification and verification, the trainee is directed to a screen 1020 where the trainee may input information identifying whether the PSE is an incident, near miss or unsafe condition as shown in FIG. 12. Also, in FIG. 12, the trainee can input which of the learner specific kinds of issues may apply to the PSE being reported.

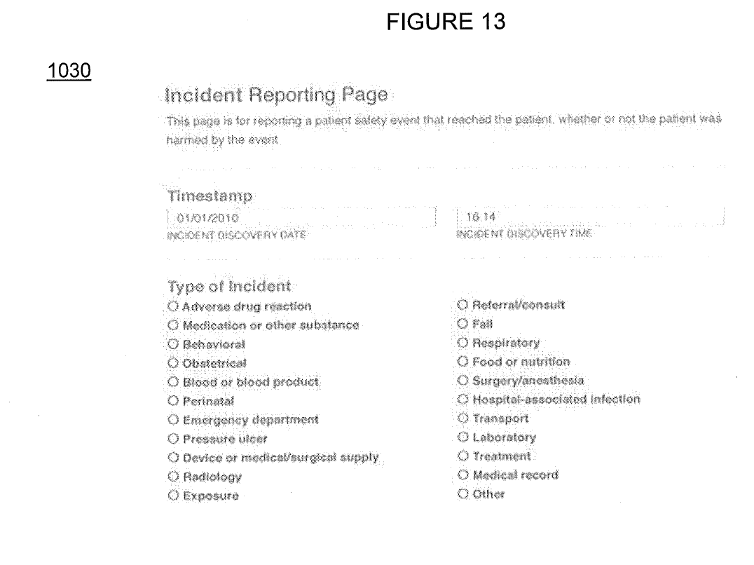

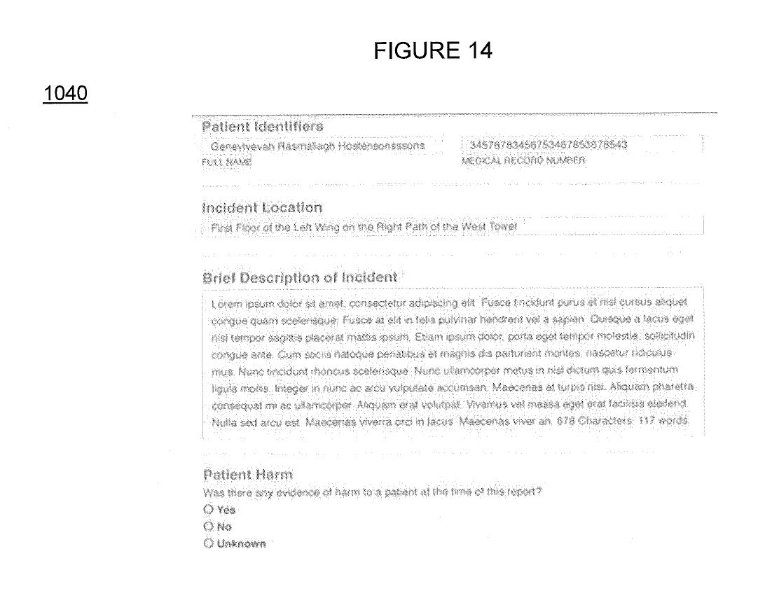

If the trainee has identified the PSE as an “incident”, the trainee is directed to the input screen 1030 as shown in FIG. 13. As shown in FIG. 13, the event date, time and broad type of category are selected. FIG. 14 provides an input screen 1040 of other PSE related information, specifically, patient identifiers, event location, a brief free text description and whether harm occurred to the patient. According to the present invention, various incident subtypes are contemplated as shown by the tables below:

TABLE 1
Administration Related Incident Types

ADM - Policy inadequate
ADM - Policy not followed
ADM - Policy unclear
ADM - Risk Management Consult
ADM - Abduction of patient of any age

TABLE 2
Adverse Drug Reactions

ADR - Allergic Reaction
ADR - Non-Allergic Reaction

TABLE 3
Blood Transfusion Related Incident Types

BT - Apparent transfusion reaction
BT - Event related to administration
BT - Event related to dispensing or distribution
BT - Mismatched unit
BT - Related to product sample collection
BT - Special product need not issued
BT - Special product need not requested
BT - Wrong component issued
BT - Wrong component requested
BT - Wrong patient requested
BT - Wrong patient transfused

TABLE 4
Emergency Department Incident Types

ED - Discrepancy b/w ED interpretation of diagnostic final reads
ED - DOA w/in 7 days after ED Mgmt
ED - DOA w/in 72 hrs after ED Mgmt
ED - Unplanned return to ED in 48 hrs requiring admit
ED - AMA/AWOL before evaluation

TABLE 5
Equipment Related Incident Types

EQ - Delay in delivery
EQ - Electrical problem
EQ - Malfunction
EQ - Medical device problem
EQ - Not available or Inadequate supply
EQ - Operator error
EQ - Other
EQ - Preventative maintenance
EQ - Wrong equipment or inadequate
EQ - Wrong setting
EQ - Contaminated device

TABLE 6
Exposure Related Incident Types

EXP - Accidental injury
EXP - Blood and/or body fluid
EXP - Chemicals
EXP - Contamination
EXP - Inhalation-Ingestion
EXP - Needlestick
EXP - Other
EXP - Radiation
EXP - Burn

TABLE 7
Fall Incident Types

FALL - Ambulating with permission
FALL - Ambulating without permission
FALL - During transfer
FALL - Fainting/seizures
FALL - From bed
FALL - Other
FALL - Shower, tub toilet unattended
FALL - Shower, tub, toilet attended
FALL - Table/chair

TABLE 8
Food & Nutrition Related Incident types

FNT - Blue food coloring issue
FNT - Delay in tray delivery
FNT - Drug/food interaction issue
FNT - Food not sent
FNT - Food spoiled/expired
FNT - Foreign object in food
FNT - NPO patient receives tray
FNT - Received food patient is allergic to
FNT - Tube feeding problem
FNT - Wrong diet received
FNT - Wrong/inappropriate items on tray

TABLE 9
Health Information Management Related Incident Types

HIM - Chart lost
HIM - Consent absent from chart
HIM - Consent Incomplete
HIM - Consent Incorrect
HIM - Inappropriate documentation
HIM - Incomplete
HIM - Medical records wrong/incorrect
HIM - Missing
HIM - Procedure not documented

TABLE 10
Lab Related Incident Types

LAB - Critical lab value not reported
LAB - Delay in reporting lab results
LAB - Lost specimen
LAB - Lost test result
LAB - Results reported inaccurately
LAB - Specimen improperly collected
LAB - Specimen mislabeled
LAB - Specimen not drawn/collected
LAB - Test result mislabeled
LAB - Wrong patient
LAB - Wrong test
LAB - Wrong tubing

TABLE 11
Medication Related Incident Types

MED - Wrong Administration Technique
MED - Allergy known and drug administered
MED - Cabinet Stocking Error
MED - Delay in med delivery from pharmacy
MED - Drug product quality problem
MED - Med given w/o order
MED - Medication List incorrect
MED - Monitoring Error
MED - Overdose
MED - Underdose
MED - Wrong Dose
MED - Wrong Dose Form
MED - Wrong Drug
MED - Wrong label
MED - Wrong Patient
MED - Wrong Preparation of Dose
MED - Wrong Rate
MED - Wrong Route
MED - Wrong time administered
MED - Omitted
MED - Contaminated drug
MED - Wrong Order

TABLE 12
Obstetrics Related Incident Types

OB - Anesthesia Complication
OB - Circumcision morbidity
OB - Delay of delivery/treatment
OB - Fetal or Neonatal injury
OB - Intrapartum fetal death/still birth
OB - Laceration
OB - Low Apgar score <7 @ 5 minutes
OB - Low umbilical artery or vein cord pH (<7)
OB - Maternal Death (<1 year from delivery)
OB - Organ injury
OB - Postpartum Hemorrhage w/ blood transfusion or extended stay
OB - Postpartum Hemorrhage w/out blood transfusion
OB - Postpartum hysterectomy
OB - Postpartum readmission w/in 14 days
OB - Precipitous delivery
OB - Ultrasound, failure to diagnose
OB - Unattended delivery
OB - Unexpected ICU admission
OB - Unexpected return to OR
OB - Uterine rupture

TABLE 13
Radiology Related Incident Types

RAD - Abnormal results returned after pt d/c
RAD - Delayed
RAD - Discrepancy b/w prelim and final read
RAD - Film unavailable or inadequate
RAD - Incorrect reading
RAD - Not completed
RAD - Not ordered
RAD - Ordered, not preformed
RAD - Reaction to contrast agent
RAD - Report unavailable
RAD - Unanticipated radiation exposure
RAD - Wrong order
RAD - Wrong patient
RAD - Wrong procedure

TABLE 14
Referral/Consult Related Incident Types

RC - Arrest w/in 24 hours of transfer to UIMC
RC - Delay in scheduling
RC - Delay in service
RC - Report unavailable/delayed

TABLE 15
Respiratory Therapy Related Incident Types

RT - Medical gas problem
RT - Missed Treatment
RT - Order not available
RT - Self/Unplanned Extubation
RT - Unplanned/Emergent intubation
RT - Vent alarms not audible
RT - Vent alarms not set properly
RT - Vent settings wrong/changed w/out authorization

TABLE 16
Transport Related Incident Types

TP - Complication/Injury during transport
TP - Delay in transfer
TP - Improper hand-off to receiving unit
TP - Transport to ER for urqert care
TP - Transport to wrong destination
TP - Transport w/out proper equipment documentation
TP - Transport w/out proper staff member
TP - Wrong Patient
TP - Infant discharged to the wrong person

TABLE 17
Treatment/Procedure Related Incident Types

TX - Breach in sterile technique
TX - Complication during procedure, treatment or test
TX - Complication following procedure, treatment, or test
TX - Count incomplete/incorrect
TX - Death w/in 1 week after restraints
TX - Death w/in 24 hours after restraints
TX - Death while in restraints
TX - Failure to Diagnose
TX - Failure to follow-up
TX - Failure to obtain consent
TX - Improper patient preparation
TX - Improper performance
TX - Improper technique
TX - Injury related to treatment/procedure
TX - IV Infiltrate
TX - IV site complication
TX - Misdiagnosis
TX - Preparation inadequate/wrong
TX - Procedure aborted
TX - Procedure cancelled
TX - Procedure delayed
TX - Procedure incorrect
TX - Procedure unordered
TX - Refusal of treatment
TX - Retained foreign body
TX - Treatment Delayed
TX - Unexpected arrest
TX - Unexpected return to OR
TX - Unintended laceration or puncture
TX - Unplanned procedure
TX - Wrong patient
TX - Wrong procedure
TX - Wrong side
TX - Wrong site
TX - IV/Lines/Tubes dislodged
TX - Acquired pressure sore in hospital
TX - Acquired Stage 3 or 4 pressure ulcers in hospital
TX - AMA/AWOL/Elopement
TX - Care provided by someone impersonating a healthcare provider
TX - Complication of spinal manipulative therapy
TX - Complication as a result of hypoglycemia (onset in hospital)
TX - Complication during electric shock or elective cardioversion
TX - Death in ASA Class 1 Patient
TX - Failure to identify and treat hyperbilirubinemia in neonates
TX - Intravascular air embolism
TX - Wrong donor sperm, or donor egg
TX - Wrong gas or oxygen line used

TABLE 18
Behavioral Related Incident Types

BH - Attempted AWOL
BH - Contraband
BH - Improper/happropriate by patient
BH - Inappropriate behavior by staff
BH - Inappropriate behavior by visitor
BH - Patient-to-Staff altercation
BH - Patient-to-Patient altercation
BH - Refusal of psych therapy
BH - Self-Inflicted injury
BH - Sexual activity
BH - Sexual assault
BH - Suicide attempt
BH - Suicide completed
BH - Physical assault

TABLE 19
Infectious Disease Related Incident Types

ID - Acquired in hospital (nosocomial infection)
ID - Antibiotic - resistant orqanism
ID - Antibiotic-associated diarrhea
ID - Failure to isolate
ID - Intravascular catheter infection
ID - Nosocomial pneumonia
ID - Sepsis 48 hrs post admit
ID - Wound or surgical site infection

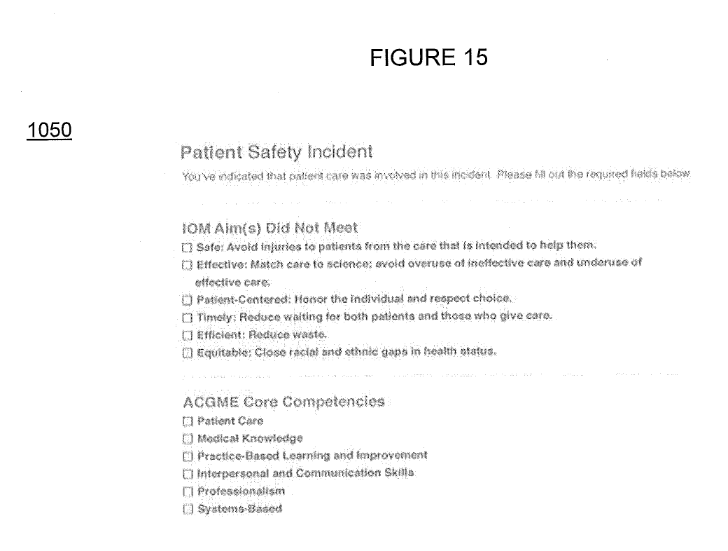

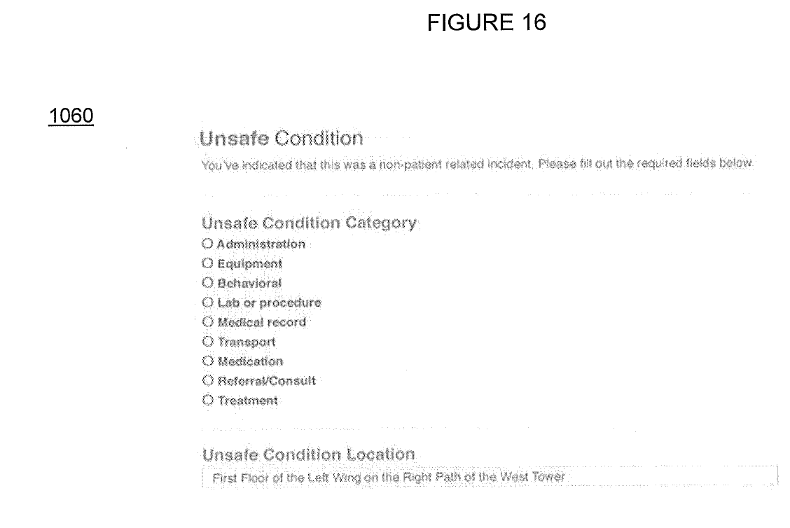

If the trainee has identified the event as an “unsafe condition” on screen 1020 shown in FIG. 12, the trainee is directed to screen 1060 as shown in FIG. 16. Regardless of whether the trainee identifies the PSE as an incident, near miss or unsafe condition, the trainee is directed to the input screen 1050 as shown in FIG. 15 to identify and choose the applicable IOM AIMS and ACGME core competencies associated with the event.

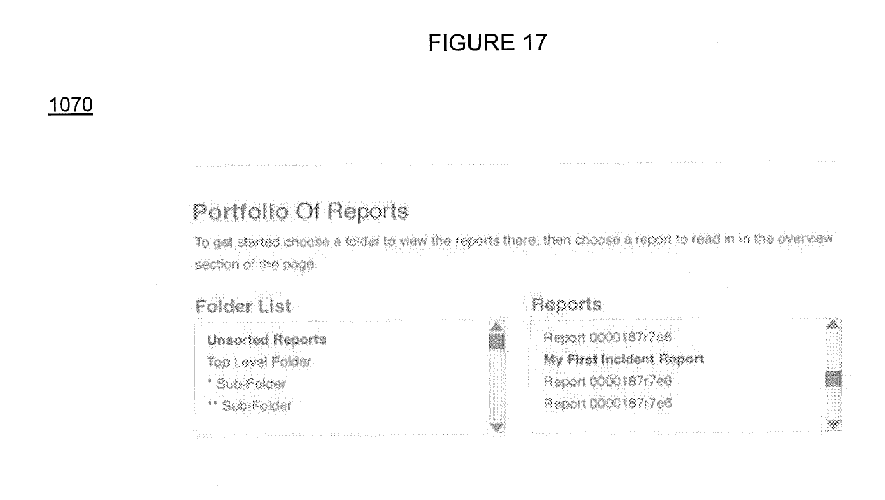

Finally, at any point the trainee or other reporter may access summaries of past PSE reports through an input screen 1070 as shown in FIG. 17. Specifically, FIG. 17 illustrates the trainee's portfolio of events. The portfolio contains data from the specific trainee's past PSE reports for review. It is contemplated that the trainee may add additional information to one or more reports of the portfolio.

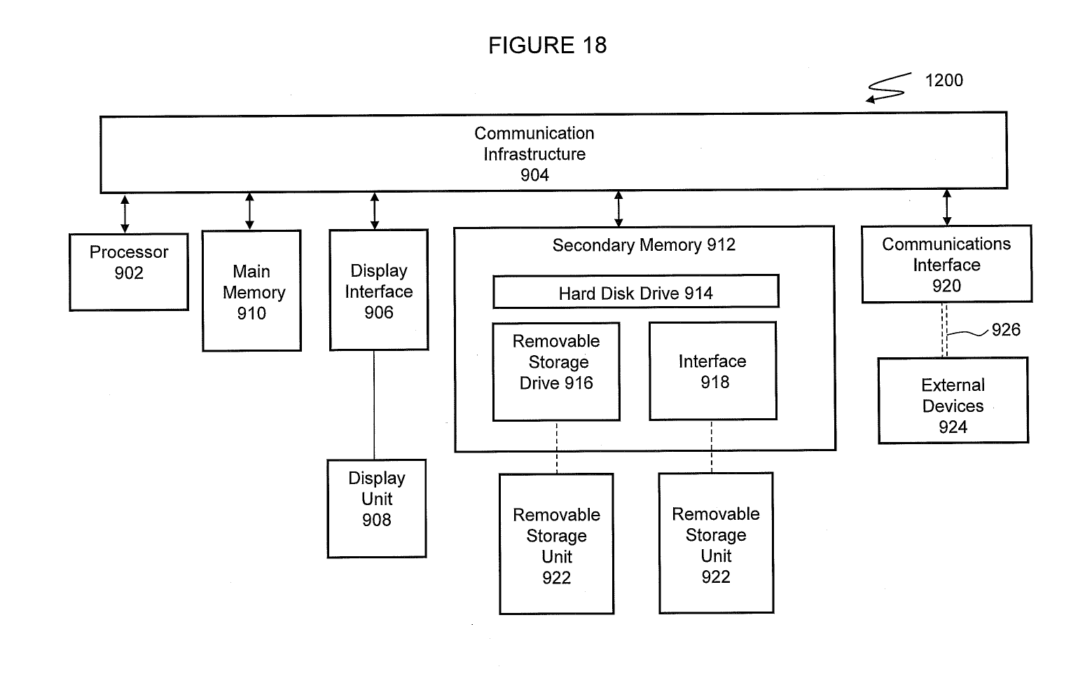

FIG. 18 illustrates an exemplary computer system 900, or network architecture, that may be used to implement the methods according to the present invention. One or more computer systems 900 may carry out the methods presented herein as computer code. One or more processors, such as processor 902, which may be a special purpose or a general-purpose digital signal processor, is connected to a communications infrastructure 904. Computer system 900 may further include a display interface 906, also connected to communications infrastructure 904, which forwards information such as graphics, text, and data, from the communication infrastructure 904 or from a frame buffer (not shown) to display unit 908. Computer system 900 also includes a main memory 910, for example random access memory (RAM), read-only memory (ROM), mass storage device, or any combination thereof. Computer system 900 may also include a secondary memory 912 such as a hard disk drive 914, a removable storage drive 916, an interface 918, or any combination thereof. Computer system 900 may also include a communications interface 920, for example, a modem, a network interface (such as an Ethernet card), a communications port, a PCMCIA slot and card, wired or wireless systems, etc.

It is contemplated that the main memory 910, secondary memory 912, communications interface 920, or a combination thereof function as a computer usable storage medium, otherwise referred to as a computer readable storage medium, to store and/or access computer software and/or instructions.

Removable storage drive 916 reads from and/or writes to a removable storage unit 922. Removable storage drive 916 and removable storage unit 922 may indicate, respectively, a floppy disk drive, magnetic tape drive, optical disk drive, and a floppy disk, magnetic tape, optical disk, to name a few.

In alternative embodiments, secondary memory 912 may include other similar means for allowing computer programs or other instructions to be loaded into the computer system 900, for example, an interface 918 and a removable storage unit 922. Removable storage units 922 and interfaces 918 allow software and instructions to be transferred from the removable storage unit 922 to the computer system 900 such as a program cartridge and cartridge interface (such as that found in video game devices), a removable memory chip (such as an EPROM, or PROM) and associated socket, etc.

Communications interface 920 allows software and instructions to be transferred between the computer system 900 and external devices 924. Software and instructions transferred by the communications interface 920 are typically in the form of signals 926 which may be electronic, electromagnetic, optical or other signals capable of being sent and received by the communications interface 920. Signals 926 may be sent and received using wire or cable, fiber optics, a phone line, a cellular phone link, a Radio Frequency (“RF”) link or other communications channels.

Computer programs, also known as computer control logic, are stored in main memory 910 and/or secondary memory 912. Computer programs may also be received via communications interface 920. Computer programs, when executed, enable the computer system 900, particularly the processor 902, to implement the methods according to the present invention. The methods according to the present invention may be implemented using software stored in a computer program product and loaded into the computer system 900 using removable storage drive 916, hard drive 914 or communications interface 920. The software and/or computer system 900 described herein may perform any one of, or any combination of, the steps of any of the methods presented herein. It is also contemplated that the methods according to the present invention may be performed automatically, or may be invoked by some form of manual intervention

The invention is also directed to computer products, otherwise referred to as computer program products, to provide software to the computer system 900. Computer products store software on any computer useable medium. Such software, when executed, implements the methods according to the present invention. Embodiments of the invention employ any computer useable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, cloud computing networks, etc.). It is to be appreciated that the embodiments described herein can be implemented using software, hardware, firmware, or combinations thereof.

The computer system 900, or network architecture, of FIG. 18 is provided only for purposes of illustration, such that the present invention is not limited to this specific embodiment. It is appreciated that a person skilled in the relevant art knows how to program and implement the invention using any computer system or network architecture.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A system for generating a database, including a national database, of health care trainee reported patient safety events for use as an educational tool for teaching patient safety to trainees, including resident physicians, comprising:
a user interface to enter information regarding a patient safety event;
a processor to create a report based on the information regarding the patient safety event;
a memory to store the report; and
a communication interface to transmit the report to a Patient Safety Organization or any other database.

2. A method for generating a database of health care trainee reported patient safety events for use as an educational tool for teaching patient safety to trainees, including resident physicians, comprising the steps of:
entering into a user interface information regarding a patient safety event;
creating by a processor a report based on the information regarding the patient safety event;
storing the report within a memory; and
transmitting the report by a communication interface to the database.

3. The method for generating a database according to claim 2, wherein the database is a national database.

4. A system including a data-entry platform to prepare reports related to any health care professional trainee, including resident physician observed events, comprising:
a processor to validate information of at least one user name and password;
a first user interface to receive an occurrence selected from the group of a patient-type occurrence and a non-patient-type occurrence that will include patient safety incidents, patient safety “near misses” and “unsafe conditions”;
a second user interface to receive an incident category selected from a plurality of categories including at least one selected from the group of incident location, brief description of the occurrence, hospital location, name of patient and patient medical record number;
a third user interface to receive information related to one or more Institute of Medicine aims for improvement, wherein said processor evaluates the one or more aims for improvement;
a fourth user interface to receive information related to one or more ACGME core competencies, wherein said processor assesses the occurrence and prepares a completed report;
a database for storing the completed report; and
a communications interface for transmitting immediately the completed report for access by one or more parties.

5. The system including a data-entry platform according to claim 4, further comprising a fifth user interface to provide the trainee with immediate automated feedback, including educational assessment questions, based on a category and a description of events that includes at least one selected from the group of references of peer reviewed literature and best practices related to the patient safety event reported.

6. A method for preparing reports related to trainee observed events, comprising the steps of:
providing valid access information of at least one user name and password;
creating an event record, wherein said creating step further comprises the steps of:
entering a patient safety event selected from the group of a patient-type occurrence and a non-patient-type occurrence including “patient safety incidents”, “near misses” and “unsafe conditions”, said entering step further including the step of selecting an incident category from a plurality of categories including at least one of the following: event location, brief description of the event, hospital location, name of patient and patient medical record number;
evaluating the patient safety event, said evaluating step including the step of inputting information related to one or more IOM aims for improvement;
assessing the patient safety event, said assessing step including the step of providing information related to one or more core competencies;
submitting the event record; and
transmitting immediately the event record for access by one or more parties.

7. The method for preparing reports related to trainee observed events according to claim 6, further comprising the step of offering an automated educational feedback and assessment tool to provide the trainee with immediate automated feedback, including educational assessment questions, based on a category and a description of events that includes at least one selected from the group of references and abstracts of peer reviewed literature and best practices related to the patient safety event reported.

8. The method for preparing reports related to trainee observed events according to claim 7, wherein said offering step further comprises the step of preparing a portfolio that tracks and evaluates the educational and training progress over the continuum of the academic career of the trainee through assessment of PSE reports and subsequent follow-up.

9. A computer system method for creating a disclosure program for a trainee based on observed events, comprising the steps of:
notifying patient safety/risk management personnel immediately about an unexpected patient safety event involving harm to a patient;
utilizing standard Root Cause Analysis techniques related to the event to determine whether one or more errors occurred;
creating at least one communication program for providing ongoing communication with the patient following an unexpected patient safety event;
providing an apology and an appropriate remedy to the patient;
displaying the apology to the and
linking process improvements identified in the Root Cause Analysis with patient involvement.

10. A computer system for creating a disclosure program for communication to a patient, comprising:
an electronic device, wherein said electronic device notifies patient safety/risk management personnel immediately about an unexpected patient safety event involving harm to a patient;
a processor to determine whether one or more errors occurred, wherein said processor utilizes standard Root Cause Analysis techniques related to the event and creates at least one communication program for providing ongoing communication with the patient following an unexpected patient safety event;
a user interface, wherein said user interface displays an apology and an appropriate remedy for communication to the patient.
